(19) United States
(12) Patent Application Publication
(10) Pub. No.: US 2012/0236064 A1
(43) Pub. Date: Sep. 20, 2012

(54) Solvent Based Magnetic Ink Comprising Carbon Coated Magnetic Nanoparticles And Process For Preparing Same

(75) Inventors: Gabriel Iftime, Mississauga (CA); Peter G. Odell, Mississauga (CA); C. Geoffrey Allen, Waterdown (CA); Richard P.N. Veregin, Mississauga (CA); Marcel P. Breton, Mississauga (CA); Guiqin Song, Milton (CA)

(73) Assignee: Xerox Corporation, Norwalk, CT (US)

(21) Appl. No.: 13/049,937

(22) Filed: Mar. 17, 2011

(51) Int. Cl. B41J 2/015; C09D 11/02

(52) U.S. Cl. 347/20; 106/31.92

(57) ABSTRACT

A magnetic ink including an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover.

### RELATED APPLICATIONS

Commonly assigned U.S. patent application Ser. No. ______ (Serial Number not yet assigned, Attorney Docket number 20100852-US-NP, entitled “Phase Change Magnetic Ink Comprising Carbon Coated Magnetic Nanoparticles And Process For Preparing Same”), filed concurrently herewith, is hereby incorporated by reference herein in its entirety.

Commonly assigned U.S. patent application Ser. No. ______ (Serial Number not yet assigned, Attorney Docket number 20101090-US-NP), entitled “Magnetic Curable Inks,” filed concurrently herewith, is hereby incorporated by reference herein in its entirety.

Commonly assigned U.S. patent application Ser. No. ______ (Serial Number not yet assigned, Attorney Docket number 20101179-US-NP, entitled “Phase Change Magnetic Ink Comprising Surfactant Coated Magnetic Nanoparticles And Process For Preparing Same”), filed concurrently herewith, is hereby incorporated by reference herein in its entirety.

Commonly assigned U.S. patent application Ser. No. ______ (Serial Number not yet assigned, Attorney Docket number 20101180-US-NP, entitled “Phase Change Magnetic Ink Comprising Coated Magnetic Nanoparticles And Process For Preparing Same”), filed concurrently herewith, is hereby incorporated by reference herein in its entirety.

Commonly assigned U.S. patent application Ser. No. ______ (Serial Number not yet assigned, Attorney Docket number 20101181-US-NP, entitled “Phase Change Magnetic Ink Comprising Polymer Coated Magnetic Nanoparticles And Process For Preparing Same”), filed concurrently herewith, is hereby incorporated by reference herein in its entirety.

Commonly assigned U.S. patent application Ser. No. ______ (Serial Number not yet assigned, Attorney Docket number 20101182-US-NP, entitled “Phase Change Magnetic Ink Comprising Inorganic Oxide Coated Magnetic Nanoparticles And Process For Preparing Same”), filed concurrently herewith, is hereby incorporated by reference herein in its entirety.

Commonly assigned U.S. patent application Ser. No. ______ (Serial Number not yet assigned, Attorney Docket number 20101215-US-NP, entitled “Curable Inks Comprising Inorganic Oxide-Coated Magnetic Nanoparticles”), filed concurrently herewith, is hereby incorporated by reference herein in its entirety.

Commonly assigned U.S. patent application Ser. No. ______ (Serial Number not yet assigned, Attorney Docket number 20101216-US-NP, entitled “Curable Inks Comprising Polymer-Coated Magnetic Nanoparticles”), filed concurrently herewith, is hereby incorporated by reference herein in its entirety.

Commonly assigned U.S. patent application Ser. No. ______ (Serial Number not yet assigned, Attorney Docket number 20101217-US-NP, entitled “Curable Inks Comprising Coated Magnetic Nanoparticles”), filed concurrently herewith, is hereby incorporated by reference herein in its entirety.

Commonly assigned U.S. patent application Ser. No. ______ (Serial Number not yet assigned, Attorney Docket number 20101218-US-NP, entitled “Curable Inks Comprising Surfactant-Coated Magnetic Nanoparticles”), filed concurrently herewith, is hereby incorporated by reference herein in its entirety.

Commonly assigned U.S. patent application Ser. No. ______ (Serial Number not yet assigned, Attorney Docket number 20101344-US-NP, entitled “Solvent-Based Inks Comprising Coated Magnetic Nanoparticles”), filed concurrently herewith, is hereby incorporated by reference herein in its entirety.

Commonly assigned U.S. patent application Ser. No. ______ (Serial Number not yet assigned, Attorney Docket number 20101347-US-NP, entitled “Solvent-Based Inks Comprising Coated Magnetic Nanoparticles”), filed concurrently herewith, is hereby incorporated by reference herein in its entirety.

### BACKGROUND

Disclosed herein is a magnetic ink comprising an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover.

Non-digital inks and printing elements suitable for MICR printing are known. The two most commonly known technologies are ribbon based thermal printing systems and offset technology. For example, U.S. Pat. No. 4,463,034, which is hereby incorporated by reference herein in its entirety, discloses a heat sensitive magnetic transfer element for printing a magnetic image to be recognized by a magnetic ink character reader, comprising a heat resistant foundation and a heat sensitive imaging layer. The imaging layer is made of a ferromagnetic substance dispersed in a wax and is transferred onto a receiving paper in the form of magnetic image by a thermal printer which uses a ribbon.

U.S. Pat. No. 5,866,637, which is hereby incorporated by reference herein in its entirety, discloses formulations and ribbons which employ wax, binder resin and organic molecule based magnets which are to be employed for use with a thermal printer which employs a ribbon.

MICR ink suitable for offset printing using a numbering box are typically thick, highly concentrated pastes consisting, for example, of over about 60% magnetic metal oxides dispersed in a base containing soy based varnishes. Such inks are commercially available, such as from Heath Custom Press (Auburn, Wash.).

Digital water-based ink-jet inks composition for MICR applications using a metal oxide based ferromagnetic particles of a particle size of less than 500 microns are disclosed in U.S. Pat. No. 6,767,396 (M. J. McElligott et al.) Water based inks are commercially available from Diversified Nano Corporation (San Diego, Calif.).

Magnetic inks are required for two main applications: (1) Magnetic Ink Character Recognition (MICR) for automated check processing, and (2) security printing for document authentication. MICR ink contains a magnetic pigment or a magnetic component in an amount sufficient to generate a magnetic signal strong enough to be readable via a MICR reader. Generally, the ink is used to print all or a portion of a document, such as checks, bonds, security cards, etc.

MICR inks or toners are made by dispersing magnetic particles into an ink base. There are numerous challenges in developing a MICR ink jet ink. For example, most ink jet printers limit considerably the particle size of any particulate components of the ink, due to the very small size of the ink jet print head nozzle that expels the ink onto the substrate. The size of the ink jet head nozzle openings are generally on the order of about 40 to 50 microns, but can be less than 10 microns in diameter. This small nozzle size requires that the particulate matter contained in an ink jet ink composition must be of a small enough size to avoid nozzle clogging problems. Even when the particle size is smaller than the nozzle size, the particles can still agglomerate or cluster together to the extent that the size of the agglomerate exceeds the size of the nozzle opening, resulting in nozzle blockage. Additionally, particulate matter may be deposited in the nozzle during printing, thereby forming a crust that results in nozzle blockage and/or imperfect flow parameters.

Further, a MICR ink jet ink must be fluid at jetting temperature and not dry. An increase in pigment size can cause a corresponding increase in ink density thereby making it difficult to maintain the pigments in suspension or dispersion within a liquid ink composition.

MICR inks contain a magnetic material that provides the required magnetic properties. The magnetic material must retain a sufficient charge so that the printed characters retain their readable characteristic and are easily detected by the detection device or reader. The magnetic charge retained by a magnetic material is known as “remanence.” The magnetic material must exhibit sufficient remanence once exposed to a source of magnetization in order to generate a MICR-readable signal and have the capability to retain the same over time. Generally, an acceptable level of charge, as set by industry standards, is between 50 and 200 Signal Level Units, with 100 being the nominal value, which is defined from a standard developed by the American National Standards Institute. A lesser signal may not be detected by the MICR reading device, and a greater signal may not give an accurate reading. Because the documents being read employ the MICR printed characters as a means of authenticating or validating the presented documents, it is important that the MICR characters or other indicia be accurately read without skipping or misreading characters. Therefore, for purposes of MICR, remanence is preferably a minimum of 20 emu/g (electromagnetic unit/gram). A higher remanence value corresponds to a stronger readable signal.

Remanence tends to increase as a function of particle size of the magnetic pigment coating. Accordingly, when the magnetic particle size decreases, the magnetic particles experience a corresponding reduction in remanence. Achieving sufficient signal strength thus becomes increasingly difficult as the magnetic particle size diminishes and the practical limits on percent content of magnetic particles in the ink composition are reached. A higher remanence value will require less total percent magnetic particles in the ink formula, improve suspension properties, and reduce the likelihood of settling as compared to an ink formula with a higher percent magnetic particle content.

Additionally, MICR ink jet inks must exhibit low viscosity, typically on the order of less than 15 centipoise (cP) or about 2 to about 12 cP at jetting temperature (jetting temperature ranging from about 25° C. to about 140° C.) in order to function properly in both drop-on-demand type printing equipment, such as printers and piezoelectric printers, and continuous type printing apparatus. The use of low viscosity fluids, however, adds to the challenge of successfully incorporating magnetic particles into an ink dispersion because particle settling will increase in a less viscous fluid as compared to a more viscous fluid.

U.S. Patent Publication Number 2009/0321676A1, which is hereby incorporated by reference herein in its entirety, describes in the Abstract thereof an ink including stabilized magnetic single-crystal nanoparticles, wherein the value of the magnetic anisotropy of the magnetic nanoparticles is greater than or equal to 2×10⁴ J/m³. The magnetic nanoparticle may be a ferromagnetic nanoparticle, such as FePt. The ink includes a magnetic material that minimizes the size of the particle, resulting in excellent magnetic pigment dispersion stability, particularly in non-aqueous ink jet inks. The smaller sized magnetic particles of the ink also maintain excellent magnetic properties, thereby reducing the amount of magnetic particle loading required in the ink.

Magnetic metal nanoparticles are desired for MICR inks because magnetic metal nanoparticles have the potential to provide high magnetic remanence, a key property for enabling MICR ink. However, in many cases, unprotected or surfactant protected magnetic metal nanoparticles are pyrophoric and thus constitute a safety hazard. Large scale production of phase change inks with such particles is difficult because air and water need to be removed when handling these highly oxidizable particles. In addition, the ink preparation process is particularly challenging with magnetic pigments because inorganic magnetic particles can be incompatible with certain organic base ink components.

As noted, magnetic metal nanoparticles are pyrophoric and can be extremely air and water sensitive. Magnetic metal nanoparticles, such as iron nanoparticles of a certain size, typically in the order of a few tens of nanometers, have been known to ignite spontaneously when contacted with air. Iron nanoparticles packaged in vacuum sealed bags have been known to become extremely hot even when opened in inert atmosphere, such as in an argon environment, and have been known to oxidize quickly by the traces of oxygen and water in the argon gas, even when the oxygen and water was present at only about 5 parts per million each, and to lose most of their magnetic remanence property. Large scale production of inks with such particles is problematic because air and water need to be removed when handling these materials.

Currently available MICR inks and methods for preparing MICR inks are suitable for their intended purposes. However, a need remains for MICR ink jet inks that have reduced magnetic material particle size, improved magnetic pigment dispersion and dispersion stability along with the ability to maintain excellent magnetic properties at a reduced particle loading. Further, a need remains for a process for preparing a MICR ink that is simplified, environmentally safe, capable of producing a highly dispersible magnetic ink having stable particle dispersion, allowing for safe processing of metal nanoparticles that is cost effective, and that can provide robust prints.

The appropriate components and process aspects of the each of the foregoing U.S. patents and patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a magnetic ink comprising an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover.

Also described is a process for preparing a magnetic ink comprising (a) preparing a solution by combining an organic solvent, an optional dispersant, an optional synergist, and an optional colorant; (b) combining the solution of (a) with a carbon coated magnetic nanoparticle comprising a magnetic core and a carbon shell disposed thereover; (c) optionally, adding a viscosity controlling agent, an antioxidant, a binder, or a combination thereof; and (d) optionally, filtering the ink.

Also described is a process which comprises (1) incorporating into an ink jet printing apparatus a magnetic ink comprising an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover; and (2) causing droplets of the ink to be ejected in an imagewise pattern onto a substrate.

### BRIEF DESCRIPTION OF THE DRAWINGS

FIG. 1 is an illustration of the magnetic property of a paper coated with a solvent based magnetic ink of the present disclosure.

FIG. 2 is an illustration showing folding test results for a solvent based magnetic ink of the present disclosure.

### DETAILED DESCRIPTION

A magnetic ink is described comprising an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover. The carbon coating provides an effective barrier against oxygen and as a result provides significant stability against oxidation to the magnetic core of the nanoparticles. These magnetic nanoparticles can be handled in air or under regular inert atmosphere conditions with reduced risk of fire.

The magnetic inks herein can be used for any suitable or desired purpose. In embodiments, the inks herein are used as magnetic ink character recognition (MICR) inks. The inks made according to the present disclosure may be used for MICR applications as well as, for example, in magnetic encoding or in security printing applications, among others. In specific embodiments, the inks herein are used as MICR inks for automated check processing, security printing for document authentication, such as by detecting the magnetic particles in prints which otherwise appear identical. The MICR inks can be used alone or in combination with other inks or printing materials.

In embodiments, two types of magnetic metal based inks can be obtained by the process herein, depending on the particle size and shape: ferromagnetic ink and superparamagnetic ink.

In embodiments, the metal nanoparticles herein can be ferromagnetic. Ferromagnetic inks become magnetized by a magnet and maintain some fraction of the saturation magnetization once the magnet is removed. The main application of this ink is for Magnetic Ink Character Recognition (MICR) used for checks processing.

In embodiments, the inks herein can be superparamagnetic inks. Superparamagnetic inks are also magnetized in the presence of a magnetic field but they lose their magnetization in the absence of a magnetic field. The main application of superparamagnetic inks is for security printing, although not limited. In this case, an ink containing, for example, magnetic particles as described herein and carbon black appears as a normal black ink but the magnetic properties can be detected by using a magnetic sensor or a magnetic imaging device. Alternatively, a metal detecting device may be used for authenticating the magnetic metal property of secure prints prepared with this ink. A process for superparamagnetic image character recognition (i.e. using superparamagnetic inks) for magnetic sensing is described in U.S. Pat. No. 5,667,924, which is hereby incorporated by reference herein in its entirety.

The magnetic inks herein can be prepared by any suitable or desired process. In embodiments, a process for preparing a magnetic ink comprises (a) preparing a solution by combining an organic solvent, a dispersant, an optional synergist, and an optional colorant; (b) combining the solution of (a) with a carbon coated magnetic nanoparticle comprising a magnetic core and a carbon shell disposed thereover; (c) optionally, adding a viscosity controlling agent; and (d) optionally, filtering the ink.

The solvent and dispersant can be heated prior to combining with the carbon coated magnetic nanoparticles. If desired, one or more of the solvent, dispersant, optional synergist, optional antioxidant, optional viscosity controlling agent, and optional colorant can be combined and heated, followed by addition of any additional additives or non-included materials, to provide a first composition which first composition can then be combined with the carbon coated magnetic nanoparticles, followed by further processing, as suitable or desired, to form the magnetic ink composition.

Heating can comprise heating to any suitable or desired temperature. In embodiments, heating is to a temperature sufficient to solubilize the dispersant. In embodiments, heating comprises heating to a temperature of about 50 to about 200° C., or about 50 to about 150° C., or about 70 to about 140° C.

The magnetic ink components can be processed as desired to effect wetting, dispersion, and de-agglomeration of the carbon coated metal nanoparticles. For example, the components can be processed using a homogenizer, by stirring, ball milling, attrition, media milling, microfluidizing, or sonication. Microfluidizing can include, for example, using an M-110 microfluidizer or an ultimizer and passing the magnetic ink components from 1 to 10 times through the chamber. Sonication can include using a Branson 700 sonicator. In embodiments, the process herein can comprise treating to control the size of the carbon coated magnetic nanoparticles or to break up aggregations of carbon coated magnetic nanoparticles wherein treating comprises using a homogenizer, stirring, ball milling, attrition, media milling, microfluidizing, sonication, or a combination thereof.

Optional, the magnetic ink can be filtered by any suitable or desired method. Optionally, the magnetic ink can be filtered at elevated temperature. In embodiments, the magnetic ink is filtered using a nylon cloth filter.

Carbon Coated Magnetic Material.

The carbon coated metal magnetic nanoparticles herein are desirably in the nanometer size range. For example, in embodiments, the carbon coated metal nanoparticles have an average particle size (such as particle diameter or longest dimension) total size including core and shell of from about 3 to about 500 nanometers (nm), or about 10 to about 500 nm, or about 10 to about 300 nm, or about 10 to about 50 nm, or about 5 to about 100 nm, or about 2 to about 20 nm, or about 25 nm. In a specific embodiment, the magnetic nanoparticles have a volume average particle diameter of from about 3 to about 300 nanometers. Herein, “average” particle size is typically represented as d₅₀, or defined as the volume median particle size value at the 50th percentile of the particle size distribution, wherein 50% of the particles in the distribution are greater than the d₅₀ particle size value, and the other 50% of the particles in the distribution are less than the d₅₀ value. Average particle size can be measured by methods that use light scattering technology to infer particle size, such as Dynamic Light Scattering. The particle diameter refers to the length of the pigment particle as derived from images of the particles generated by Transmission Electron Microscopy or from Dynamic Light Scattering measurements.

As described above, the metal nanoparticles herein can be ferromagnetic or superparamagnetic. Superparamagnetic nanoparticles have a remanent magnetization of zero after being magnetized by a magnet. Ferromagnetic nanoparticles have a remanent magnetization of greater than zero after being magnetized by a magnet; that is, ferromagnetic nanoparticles maintain a fraction of the magnetization induced by the magnet. The superparamagnetic or ferromagnetic property of a nanoparticle is generally a function of several factors including size, shape, material selection, and temperature. For a given material, at a given temperature, the coercivity (that is, ferromagnetic behavior) is maximized at a critical particle size corresponding to the transition from multidomain to single domain structure. This critical size is referred to as the critical magnetic domain size (Dc, spherical). In the single domain range, there is a sharp decrease of the coercivity and remanent magnetization when decreasing the particle size, due to thermal relaxation. Further decrease of the particle size results in complete loss of induced magnetization because the thermal effect becomes dominant and is sufficiently strong to demagnetize previously magnetically saturated nanoparticles. Superparamagnetic nanoparticles have zero remanence and coercivity. Particles of a size of about and above the Dc are ferromagnetic. For example, at room temperature, the Dc for iron is about 15 nanometers, for fcc cobalt is about 7 nanometers, and for nickel about 55 nanometers. Further, iron nanoparticles having a particle size of 3, 8, and 13 nanometers are superparamagnetic while iron nanoparticles having a particle size of 18 to 40 nanometers are ferromagnetic. For alloys, the Dc value may change depending on the materials. For further detail, see Burke, et al., Chemistry of Materials, pages 4752-4761, 2002. For still further detail, see U.S. Publication 20090321676, (Breton, et al.), which is hereby incorporated by reference herein in its entirety; B. D. Cullity and C. D. Graham, Introduction to Magnetic Materials, IEEE Press (Wiley), 2nd Ed., 2009, Chapter 11, Fine Particles and Thin Films, pages 359-364; Lu et al., Angew. Chem. Int. Ed. 2007, 46, pages 1222-444, Magnetic Nanoparticles: Synthesis, Protection, Functionalization and Application, each of which are hereby incorporated by reference herein in their entireties.

Any suitable or desired metal can be used for the nanoparticle core in the present process. In embodiments, the magnetic nanoparticles comprise a core selected from the group consisting of Fe, Mn, Co, Ni, and mixtures and alloys thereof. In other embodiments, the magnetic nanoparticles comprise a core selected from the group consisting of Fe, Mn, Co, FePt, Ni, CoPt, MnAl, MnBi, and mixtures and alloys thereof. In certain specific embodiments, the metal nanoparticles comprise at least one of Fe, Mn, and Co.

In further embodiments, the metal nanoparticles are bimetallic or trimetallic nanoparticles.

The carbon coated metal nanoparticles are typically produced by a laser evaporation process. For example, graphite layer coated nickel nanoparticles of between 3 and 10 nanometers in diameter can be produced by laser ablation techniques. For further detail, see Q. Ou, T. Tanaka, M. Mesko, A. Ogino, and M. Nagatsu, Diamond and Related Materials, Vol. 17, Issues 4-5, pages 664-668, 2008). Alternately, carbon coated iron nanoparticles can be prepared by carbonizing polyvinyl alcohol using iron as a catalyst in hydrogen flow. For further detail, see Yu Liang An, et al., Advanced Materials Research, 92, 7, 2010). Further, carbon coated ion nanoparticles can be prepared by using an annealing procedure. The procedure induces carbonization of a stabilizing organic material, 3-(N,N-Dimethyllaurylammonio)propane sulfonate, which was used to stabilize the pre-formed iron nanoparticles. The process is performed under flow of hydrogen to ensure carbonization process. The carbon shell was found to effectively protect the iron core from oxidation in acidic solutions. For further detail, see Z. Guo, L. L. Henry, and E. J. Podlaha, ECS Transactions, 1 (12) 63-69, 2006). In embodiments, carbon materials may be selected from the group consisting of amorphous carbon, glassy carbon, graphite, carbon nanofoam, diamond, and the like.

Carbon coated metal nanoparticles can also be obtained commercially, such as from Nanoshel Corporation (Wilmington, Del., USA).

In embodiments, the magnetic nanoparticles comprise a carbon shell having a thickness of from about 0.2 to about 100 nanometers, or from about 0.5 to about 50 nanometers, or from about 1 to about 20 nanometers.

The magnetic nanoparticles may comprise any suitable or desired shape or configuration. Exemplary shapes of the magnetic nanoparticles can include, without limitation, needle-shape, granular, globular, platelet-shaped, acicular, columnar, octahedral, dodecahedral, tubular, cubical, hexagonal, oval, spherical, dendritic, prismatic, amorphous shapes, and the like. An amorphous shape is defined in the context of the present disclosure as an ill defined shape having a recognizable shape. For example, an amorphous shape has no clear edges or angles. In embodiments, the ratio of the major to minor size axis of the single nanocrystal (D major/D minor) can be less than about 10:1, less than about 2:1, or less than about 3:2. In a specific embodiment, the magnetic core has a needle-like shape with an aspect ratio of about 3:2 to less than about 10:1.

The magnetic nanoparticles may be present in the ink at any suitable or desired amount. In embodiments, the loading requirements of the magnetic nanoparticles in the ink may be from about 0.5 weight percent to about 30 weight percent, from about 5 weight percent to about 10 weight percent, or from about 6 weight percent to about 8 weight percent, although the amount can be outside of these ranges.

The magnetic nanoparticles can have any suitable or desired remanence. In embodiments, the magnetic nanoparticle can have a remanence of about 20 emu/g to about 100 emu/g, from about 30 emu/g to about 80 emu/g, or about 50 emu/g to about 70 emu/g, although the remanence can be outside of these ranges. In a specific embodiment, the magnetic nanoparticles have a remanence of about 20 emu/gram to about 100 emu/gram.

The magnetic nanoparticles can have any suitable or desired coercivity. In embodiments, the coercivity of the magnetic nanoparticle can be from about 200 Oersteds to about 50,000 Oersteds, from about 1,000 Oersteds to about 40,000 Oersteds, or from about 10,000 Oersteds to about 20,000 Oersteds, although the coercivity can be outside of these ranges.

The magnetic saturation moment can be any suitable or desired magnetic saturation moment. In embodiments, the magnetic saturation moment may be from about 20 emu/g, to about 150 emu/g, from about 30 emu/g to about 120 emu/g, or from about 40 emu/g to about 80 emu/g, although the magnetic saturation can be outside of these ranges. In a specific embodiment, the magnetic nanoparticles have a magnetic saturation moment of from about 20 emu/g to about 150 emu/g.

Organic Solvent.

The magnetic ink herein can include any desired or effective organic solvent. Examples of suitable organic solvents include isoparaffins, such as ISOPAR®, manufactured by the Exxon Corporation, hexane, toluene, methanol, ethanol, n-propanol, n-butanol, benzyl alcohol, methyl cellosolve, ethyl cellosolve, acetone, methyl ethyl ketone, cyclohexanone, chlorobenzene, methyl acetate, n-butyl acetate, dioxane, tetrahydrofuran, methylene chloride, chloroform, and mixtures and combinations thereof. Additional commercially available hydrocarbon liquids that may be used include the NORPAR® series available from Exxon Corporation, the SOLTROL® series available from the Phillips Petroleum Company, and the SHELLSOL® series available from the Shell Oil Company.

The solvent can be present in any suitable or desired amount. In embodiments, the solvent is present in the magnetic ink in an amount of about 0.1 percent to no more than about 99 percent by weight of the ink.

Dispersant.

In embodiments, a dispersant may be included in the ink. The dispersant can be added at any suitable or desired time. The dispersant's role is to ensure improved dispersion stability of the magnetic nanoparticles due to stabilizing interactions with the carbon coating material. In embodiments, the dispersant is selected from the group consisting of beta-hydroxy carboxylic acids and their esters, sorbitol esters with long chain aliphatic carboxylic acids, polymeric compounds, block copolymer dispersants, and combinations thereof. Examples of suitable dispersants include, but are not limited to, oleic acid, oleyl amine, trioctyl phosphine oxide (TOPO), hexyl phosphonic acid (HPA); polyvinylpyrrolidone (PVP), dispersants sold under the name SOLSPERSE® such as Solsperse® 16000, Solsperse® 28000, Solsperse® 32500, Solsperse® 38500, Solsperse® 39000, Solsperse® 54000, Solsperse® 17000, Solsperse® 17940 from Lubrizol Corporation, beta-hydroxy carboxylic acids and their esters containing long linear, cyclic or branched aliphatic chains, such as those having about 5 to about 60 carbons, such as pentyl, hexyl, cyclohexyl, heptyl, octyl, nonyl, decyl, undecyl, and the like; sorbitol esters with long chain aliphatic carboxylic acids, such as lauric acid, oleic acid (SPAN® 85), palmitic acid (SPAN® 40), and stearic acid (SPAN® 60), polymeric compounds such as polyvinylpyrrolidone, poly(1-vinylpyrrolidone)-graft-(1-hexadecene), poly(1-vinylpyrrolidone)-graft-(1-triacontene), poly(1-vinylpyrrolidone-co-acrylic acid), and mixture and combinations thereof. The dispersant can also include block copolymer dispersants such as pigment-philic block and solvent-philic block dispersants. In embodiments, the dispersant is selected from the group consisting of oleic acid, lauric acid, palmitic acid, stearic acid, trioctyl phosphine oxide, hexyl phosphonic acid, polyvinylpyrrolidone, poly(1-vinylpyrrolidone)-graft-(1-hexadecene), poly(1-vinylpyrrolidone)-graft-(1-triacontene), poly(1-vinylpyrrolidone-co-acrylic acid), pentyl, hexyl, cyclohexyl, heptyl, octyl, nonyl, decyl, or undecyl beta-hydroxy carboxylic acid, as well as mixtures and combinations thereof. Further examples of suitable dispersants may include Disperbyk® 108, Disperbyk® 116, (BYK), Borchi® GEN 911, Irgasperse® 2153 and 2155 (Lubrizol), acid and acid ester waxes from Clariant, for example Licowax®S. Suitable dispersants are also described in U.S. Patent Publication 2010/0292467, which is hereby incorporated by reference herein in its entirety. Further suitable dispersants are also described in U.S. patent application Ser. No. 12,641,564, which is hereby incorporated by reference herein in its entirety, and in U.S. patent application Ser. No. 12/891,619, which is hereby incorporated by reference herein in its entirety.

The dispersant can be present in the ink in any desired or effective amount for purposes of dispersing and stabilizing the nanoparticle and other optional particles present in the ink vehicle. In embodiments, the dispersant is provided in an amount of from about 0.1 to about 20, or from about 0.5 to about 12, or from about 0.8 to about 10 weight percent relative to the weight of the ink.

Synergist.

Optionally, synergists may be used in conjunction with the dispersant. The synergist can be added at any suitable or desired time. Specific examples of commercially available synergists include Solsperse® 22000 and Solsperse® 5000 (Lubrizol Advanced Materials, Inc.).

The synergist can be present in any suitable or desired amount. In embodiments, the synergist is present in the solvent ink in an amount of about 0.1 percent to about 10 percent by total weight of the ink.

Antioxidant.

The inks of the present disclosure can also optionally contain an antioxidant. The optional antioxidants of the ink compositions protect the images from oxidation and also protect the ink components from oxidation during the heating portion of the ink preparation process. Specific examples of suitable antioxidants include NAUGUARD® 524, NAUGUARD® 76, and NAUGUARD® 512, commercially available from Chemtura Corporation (Philadelphia, Pa.), IRGANOX® 1010, commercially available from BASF, and the like. When present, the optional antioxidant is present in the ink in any desired or effective amount, such as from about 0.01 percent to about 20 percent by weight of the ink.

Viscosity Modifier.

The inks of the present disclosure can also optionally contain a viscosity modifier. The viscosity of the ink composition can be tuned by using appropriate additives. Examples of suitable viscosity modifiers include aliphatic ketones, such as stearone, and the like, polymers such as polystyrene, polymethylmethacrylate, thickening agents such as those available from BYK Chemie, and others. When present, the optional viscosity modifier is present in the ink in any desired or effective amount, such as from about 0.1 to about 99 percent by weight of the ink.

Colorant.

The inks of the present disclosure can further contain a colorant compound. This optional colorant can be present in the ink in any desired or effective amount to obtain the desired color or hue, in embodiments, from about 1 percent to about 20 percent by weight of the ink. The colorant can be any suitable or desired colorant including dyes, pigments, mixtures thereof, and the like. In embodiments, the colorant selected for the magnetic inks herein is a pigment. In a specific embodiment, the colorant selected for the magnetic inks herein is carbon black.

Suitable colorants for use in the MICR ink according to the present disclosure can further include, without limitation, carbon black, lamp black, iron black, ultramarine, Nigrosine dye, Aniline Blue, Du Pont Oil Red, Quinoline Yellow, Methylene Blue Chloride, Phthalocyanine Blue, Phthalocyanine Green, Rhodamine 6C Lake, Chrome Yellow, quinacridone, Benzidine Yellow, Malachite Green, Hansa Yellow C, Malachite Green hexalate, oil black, azo oil black, Rose Bengale, monoazo pigments, disazo pigments, trisazo pigments, tertiary-ammonium salts, metallic salts of salicylic acid and salicylic acid derivatives, Fast Yellow G3, Hansa Brilliant Yellow 5GX, Disazo Yellow AAA, Naphthol Red HFG, Lake Red C, Benzimidazolone Carmine HF3CS, Dioxazine Violet, Benzimidazolone Brown HFR Aniline Black, titanium oxide, Tartrazine Lake, Rhodamine 6G Lake, Methyl Violet Lake, Basic 6G Lake, Brilliant Green lakes, Hansa Yellow, Naphthol Yellow, Rhodamine B, Methylene Blue, Victoria Blue, Ultramarine Blue, and the like.

The MICR ink made with magnetic nanoparticles is a black or dark brown. The MICR ink according to the present disclosure may be produced as a colored ink by adding a colorant during ink production. Alternatively, a MICR ink lacking a colorant (that is, free of added colorant) may be printed on a substrate during a first pass, followed by a second pass, wherein a colored ink that is lacking MICR particles is printed directly over the colored ink, so as to render the colored ink MICR-readable. In embodiments, the process herein can comprise (1) incorporating into an ink jet printing apparatus a magnetic ink comprising an organic solvent, a carbon coated magnetic nanoparticle comprising a magnetic core and a carbon shell disposed thereover, an optional dispersant, an optional synergist, an optional antioxidant, an optional viscosity controlling agent, an optional colorant, and an optional binder; and (2) causing droplets of the ink to be ejected in an imagewise pattern onto a substrate; (3) incorporating into an ink jet printing apparatus an ink comprising an ink carrier, a colorant, an optional dispersant, an optional synergist, an optional binder, and an optional antioxidant; (4) causing droplets of the ink of (3) to be ejected in an imagewise pattern onto a substrate, wherein the imagewise pattern covers the imagewise pattern of (2) such that the ink of (3) is rendered MICR-readable.

Binder Resin.

The ink composition according to the present disclosure may also include one or more binder resins. The binder resin may be any suitable agent including, without limitation, a maleic modified rosin ester (BECKACITE® 4503 resin, available from Arizona Chemical Company), phenolics, maleics, modified phenolics, rosin ester, modified rosin, phenolic modified ester resins, rosin modified hydrocarbon resins, hydrocarbon resins, terpene phenolic resins, terpene modified hydrocarbon resins, polyamide resins, tall oil rosins, polyterpene resins, hydrocarbon modified terpene resins, acrylic and acrylic modified resins and similar resins or rosin known to be used in printing inks, coatings and paints, and the like.

Other suitable binder resins include, without limitation, thermoplastic resins, homopolymers of styrene or substituted styrenes such as polystyrene, polychloroethylene, and polyvinyltoluene; styrene copolymers such as styrene-p-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-butylacrylate copolymer, styrene-octylacrylate copolymer, styrene-methylmethacrylate copolymer, styrene-ethylmethacrylate copolymer, styrene-butylmethacrylate copolymer, styrene-methyl-α-chloromethacrylate copolymer, styrene-acrylonitrile copolymer, styrene-vinylmethylether copolymer, styrene-vinylethylether copolymer, styrene-vinylmethylketone copolymer, styrene-butadiene copolymer, styrene-isoprene copolymer, styrene-acrylonitrile-indene copolymer, styrene-maleic acid copolymer, and styrene-maleic acid ester copolymer; polymethylmethacrylate; polybutylmethacrylate; polyvinyl chloride; polyvinylacetate; polyethylene; polypropylene; polyester; polyvinyl butyral; polyacrylic resin; rosin; modified rosin; terpene resin; phenolic resin; aliphatic or aliphatic hydrocarbon resin; aromatic petroleum resin; chlorinated paraffin; paraffin wax, and the like. These binder resins can be used alone or in combination.

The MICR inks of the present disclosure can be employed in apparatus for direct printing ink jet processes and in indirect (offset) printing ink jet applications. Another embodiment of the present disclosure is directed to a process which comprises incorporating a MICR solvent ink of the present disclosure into an ink jet printing apparatus and causing droplets of the ink to be ejected in an imagewise pattern onto a recording substrate. A direct printing process is also disclosed in, for example, U.S. Pat. No. 5,195,430, the disclosure of which is totally incorporated herein by reference. In embodiments, the substrate is a final recording sheet and droplets of the ink are ejected in an imagewise pattern directly onto the final recording sheet. Yet another embodiment of the present disclosure is directed to a process which comprises incorporating an ink of the present disclosure into an ink jet printing apparatus, causing droplets of the ink to be ejected in an imagewise pattern onto an intermediate transfer member, and transferring the ink in the imagewise pattern from the intermediate transfer member to a final recording substrate. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements. In embodiments, the intermediate transfer member is heated to a temperature above that of the final recording sheet and below that of the ink in the printing apparatus. Inks of the present disclosure can also be employed in other printing processes.

Any suitable substrate or recording sheet can be employed, including plain papers such as XEROX® 4200 papers, XEROX® Image Series papers, ruled notebook paper, bond paper, silica coated papers such as Sharp Company silica coated paper, JuJo® paper, Hammermill® Laserprint Paper, and the like, transparency materials, fabrics, textile products, plastics, polymeric films, inorganic substrates such as metals and wood, and the like.

In various embodiments, magnetic ink is provided which can be prepared by dispersing carbon coated metal magnetic nanoparticles in a solvent ink base. The process herein provides a process for preparation of MICR ink that is scalable, safe, and non-pyrophoric. The MICR ink can be used for various printing technologies, specifically ink jet printing technologies, and more specifically for magnetic security ink printing applications. Because it is in a liquid state when reaching the paper, the magnetic ink prepared as described herein penetrates into the paper when printed. This offers key advantages including: (1) Robust magnetic prints which can pass the machine-reading processing steps without any additional overcoat, and (2) ability to be easily overprinted with other inks. Further, the present solvent based magnetic inks provide low image pile height, eliminate the need for the overcoat protective layer previously required with certain MICR inks, ease of overprinting with additional text, and scalable processing. Further, the present disclosure provides a solvent based magnetic ink that is compatible with non-water based printers.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Example 1

Preparation of solvent based magnetic ink with carbon coated ferromagnetic nanoparticles. A 30 milliliter brown bottle was filled with 10 grams of Isopar® M (solvent) and 1.0 gram of oleic acid. The solution was heated to about 50° C. and stirred, in order to solubilize the oleic acid. To this solution were added 2.5 grams of carbon-coated iron nanoparticles (25 nanometer average size; commercially available from Nanoshel Corp., CA). Prior to addition, the particles appear like large agglomerates (millimeter size). The solution was mixed with an IKA KS 130 shaker to ensure wetting of the carbon coated iron aggregates (3 hours). 70 grams of pre-cleaned ⅛ inch diameter 440C Grade 25 steel balls were added and the composition was ball-milled for 1 day in order to induce de-agglomeration of the carbon-coated iron nanoparticles. The average particle size of the particles in the ink was about 1 micron. It is expected that smaller particles can be produced through selection of a more aggressive grinding process and appropriate dispersant additive. Attrition processes typically provide higher energy input compared to the relatively small ball-milling scale which was used. It is expected that attrition using suitable media with optional heating can provide particles having an average particle size of below 300 nanometers.

### Example 2

### Magnetic Property

An experiment was carried out whereby the ink from Example 1 was exposed to air and no temperature increase or tendency to ignite was detected during the preparation procedures. The ink was attracted by a magnet, which proves that the iron nanoparticles maintained their magnetic properties after the ink processing steps.

### Example 3

### Test Samples Preparation

Samples of the presently disclosed solvent based magnetic ink were made by coating Xerox® 4200 paper with the liquid solvent magnetic ink with a blade and with a gap of 1 mil (25 microns) and 5 mil (125 microns). The amount of disposed ink on paper provided by coatings is significantly higher when compared with regular solid ink prints which have a typical thickness of about 5 microns. This was chosen on purpose in order to provide a worst scenario case. Ink passing this robustness test indicates that it will be robust when printed as a thinner layer on paper, for example, in an actual printer.

### Example 4

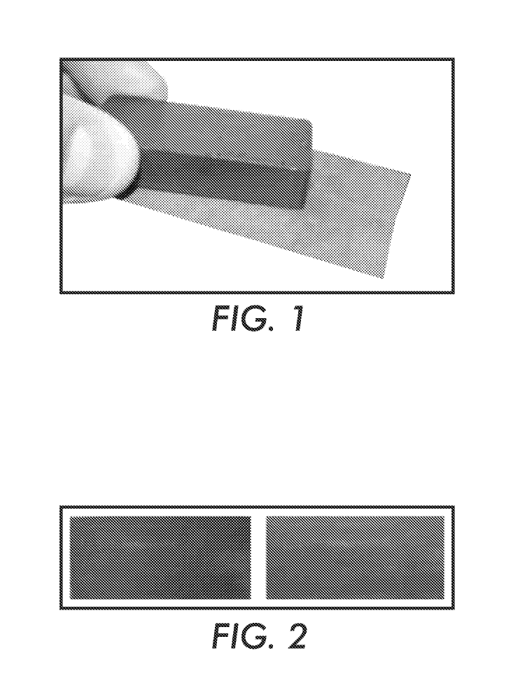

Coated regular paper (Xerox® 4200) with solvent based composition coated as described in Example 4 was attracted by a magnet. See FIG. 1 showing the magnetic attraction of a solvent based magnetic ink of Example 1 coated on regular paper, further demonstrating that the magnetic properties were maintained on a printed page.

Robustness demonstration. The robustness of prints made with solvent-based MICR ink of the present disclosure was evaluated by two different methods:

Crease (folding) test: which evaluates print stability when folding the printed page.

Rubbing (smearing) test: which evaluates robustness of the print upon rubbing.

### Example 5

FIG. 2 provides a representation of a printed ink pattern of the present solvent based magnetic ink (left side of FIG. 2). The folding test of the solvent-based ink described herein revealed that no ink had been removed along and near the folding edge (FIG. 2, right side). This demonstrated an excellent improved crease performance of the solvent-based ink.

### Example 6

Rubbing (smearing) test. Replicate samples were made as described in Example 4 and subjected to a rubbing (smearing) test to evaluate the robustness of the present magnetic solvent ink prints. The test was performed with an Ink Rub Tester from Testing Machines Inc. A rectangle printed area was rubbed (200 cycles) against a white regular paper substrate and the samples compared in two ways:

1) transfer of ink from the print to the white paper;

2) appearance of the printed area after rubbing (evaluated as the potential flaking off of ink in the printed area)

Appearance of the printed area after removal from the rubbing machine: no significant difference was detected visually before and after rubbing (200 cycles) of the printed solvent based magnetic ink pattern with prints made with the magnetic solvent ink described herein.

Further evaluation was carried out by measuring the Optical Density (OD) change of prints made with the present solvent magnetic ink before and after the rubbing test. The OD before rubbing was 0.89. The OD after rubbing was 0.87. This shows that 98% of the initial OD of the sample was conserved after rubbing. Overall, the tests showed excellent (target is >90%) rubbing performance of magnetic solvent inks of the present disclosure.

In various embodiments, magnetic ink is provided which can be prepared by dispersing carbon coated metal magnetic nanoparticles in a solvent ink base. The process herein provides a process for preparation of MICR ink that is scalable, safe, and non-pyrophoric. The MICR ink can be used for various printing technologies, specifically ink jet printing technologies, and more specifically for magnetic security ink printing applications. Because it is in a liquid state when reaching the paper, the magnetic ink prepared as described herein penetrates into the paper when printed. This offers key advantages including: (1) Robust magnetic prints which can pass the machine-reading processing steps without any additional overcoat, and (2) ability to be easily overprinted with other inks. Further, the present solvent based magnetic inks provide low image pile height, eliminate the need for the overcoat protective layer previously required with certain MICR inks, ease of overprinting with additional text, and scalable processing. Further, the present disclosure provides a solvent based magnetic ink that is compatible with non-water based printers.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A magnetic ink comprising:
an organic solvent;
an optional dispersant;
an optional synergist;
an optional antioxidant;
an optional viscosity controlling agent;
an optional colorant;
an optional binder; and
a carbon coated magnetic nanoparticle comprising a magnetic core and a carbon shell disposed thereover.

2. The magnetic ink of claim 1, wherein the magnetic nanoparticles are ferromagnetic or superparamagnetic.

3. The magnetic ink of claim 1, wherein the magnetic nanoparticles comprise a bimetallic or trimetallic core.

4. The magnetic ink of claim 1, wherein the magnetic nanoparticles comprise a core selected from the group consisting of Fe, Mn, Co, Ni, FePt, CoPt, MnAl, MnBi, and mixtures and alloys thereof.

5. The magnetic ink of claim 1, wherein the magnetic nanoparticles comprise a carbon shell having a thickness of from about 0.2 nanometers to about 100 nanometers.

6. The magnetic ink of claim 1, wherein the magnetic nanoparticles have a volume average particle diameter of from about 3 to about 300 nanometers.

7. The magnetic ink of claim 1, wherein the magnetic core has a needle-like shape with an aspect ratio of about 3:2 to less than about 10:1.

8. The magnetic ink of claim 1, wherein the magnetic nanoparticles have a magnetic saturation moment of about 20 emu/g to about 150 emu/g.

9. The magnetic ink of claim 1, wherein the magnetic nanoparticles have a remanence of about 20 emu/gram to about 100 emu/gram.

10. The magnetic ink of claim 1, wherein the organic solvent is selected from the group consisting of isoparaffins, methanol, ethanol, n-propanol, n-butanol, benzyl alcohol, methyl cellosolve, ethyl cellosolve, acetone, methyl ethyl ketone, cyclohexanone, chlorobenzene, methyl acetate, n-butyl acetate, dioxane, tetrahydrofuran, methylene chloride and chloroform.

11. The magnetic ink of claim 1, wherein the dispersant is selected from the group consisting of beta-hydroxy carboxylic acids and their esters, sorbitol esters with long chain aliphatic carboxylic acids, polymeric compounds, block copolymer dispersants, and combinations thereof.

12. A process for preparing a magnetic ink comprising:
(a) preparing a solution by combining an organic solvent, an optional dispersant, an optional synergist, and an optional colorant;
(b) combining the solution of (a) with a carbon coated magnetic nanoparticle comprising a magnetic core and a carbon shell disposed thereover;
(c) optionally, adding a viscosity controlling agent, an antioxidant, a binder, or a combination thereof; and
(d) optionally, filtering the ink.

13. The process of claim 12, further comprising treating to control the size of the carbon coated magnetic nanoparticles or to break up aggregations of carbon coated magnetic nanoparticles wherein treating comprises using a homogenizer, stirring, ball milling, attrition, media milling, microfluidizing, sonication, or a combination thereof.

14. The process of claim 12, wherein the magnetic nanoparticles comprise a bimetallic or trimetallic core.

15. The process of claim 12, wherein the magnetic nanoparticles comprise a core selected from the group consisting of Fe, Mn, Co, Ni, FePt, CoPt, MnAl, MnBi, and mixtures and alloys thereof.

16. The process of claim 12, wherein the magnetic nanoparticles comprise a carbon shell comprising amorphous carbon, glassy carbon, graphite, and combinations thereof.

17. The process of claim 12, wherein the organic solvent is selected from the group consisting of isoparaffins, methanol, ethanol, n-propanol, n-butanol, benzyl alcohol, methyl cellosolve, ethyl cellosolve, acetone, methyl ethyl ketone, cyclohexanone, chlorobenzene, methyl acetate, n-butyl acetate, dioxane, tetrahydrofuran, methylene chloride, chloroform, and combinations thereof.

18. A process which comprises:
(1) incorporating into an ink jet printing apparatus a magnetic ink comprising an organic solvent; an optional dispersant; an optional synergist; an optional antioxidant; an optional viscosity controlling agent; an optional colorant; an optional binder; and a carbon coated magnetic nanoparticle comprising a magnetic core and a carbon shell disposed thereover; and
(2) causing droplets of the ink to be ejected in an imagewise pattern onto a substrate.

19. The process of claim 18, wherein the magnetic nanoparticles comprise a core selected from the group consisting of Fe, Mn, Co, Ni, FePt, CoPt, MnAl, MnBi, and mixtures and alloys thereof.

20. The process of claim 18, further comprising steps (1) and (2) and further comprising:
(3) incorporating into an ink jet printing apparatus an ink comprising an ink carrier, a colorant, an optional dispersant, an optional synergist, and an optional antioxidant;
(4) causing droplets of the ink of (3) to be ejected in an imagewise pattern onto a substrate, wherein the imagewise pattern covers the imagewise pattern of (2) such that the ink of (3) is rendered MICR-readable.
